(19) United States
(12) Patent Application Publication
(10) Pub. No.: US 2013/0231780 A1
(43) Pub. Date: Sep. 5, 2013

(54) TANK MIXING ORDER TOOL

(71) Applicant: PRECISION LABORATORIES, LLC, Waukegan, IL (US)

(72) Inventors: James D. Reiss, West Dundee, IL (US); Daniel J. Ori, Lake Bluff, IL (US); Richard L. Wohlner, Highland Park, IL (US)

(73) Assignee: PRECISION LABORATORIES, LLC, Waukegan, IL (US)

(21) Appl. No.: 13/782,711

(22) Filed: Mar. 1, 2013

Related U.S. Application Data
(60) Provisional application No. 61/605,553, filed on Mar. 1, 2012.

(51) Int. Cl. G05D 21/00

(52) U.S. Cl. CPC G05D 21/00
USPC 700/266

(57) ABSTRACT

A tool for optimizing a mixing order among various water soluble agricultural chemicals uses a table of mixing sequence by formulation type and another table of formulation type by the brand name or generic name of a number of chemicals from various manufacturers. The tool matches selected chemicals to their formulation type and orders the selected chemicals in a sequence according to the table of mixing sequence. Additional features include retrieval of label data, bar code recognition of chemicals and storing application data using GPS information and downloaded weather data for a day of chemical application.

### CROSS REFERENCE TO RELATED APPLICATIONS

This patent claims priority to U.S. Provisional Application No. 61/605,553 filed Mar. 1, 2012, which is hereby incorporated by reference for all purposes.

### TECHNICAL FIELD

The present disclosure generally relates to a system and method for determining a mixing order for creating water-based solutions using more than one chemical.

### BACKGROUND

Applicators of plant protection products, such as farmers, landscapers, etc., are under increased pressure to become more efficient in their operations and to increase crop yield or turf performance. The applicators may apply chemicals of many varieties to soil, crops, weeds, insects, fungi, etc., to increase crop yield. However, repeated applications of these separate chemicals are costly both in terms of fuel and labor. Increasingly, applicators are turning to the application of more than one chemical at a time by mixing the chemicals prior to application.

### SUMMARY

While mixing chemicals can be as easy as pouring the chemical into a tank, there are over twenty-five identified formulation types for agricultural chemicals, including wettable powders, flowable concentrates, emulsified concentrates, etc., represented by over one thousand generic and brand name agricultural chemical products. Some formulation types, when mixed in the wrong sequence can coagulate, gel, etc. causing , among other things, clogged sprayer tanks, tubes and nozzles. Moreover the active ingredients may leave the solution or settle in the solution such that only water is applied, leaving the active ingredients in the tank. Clogged tanks, lines, and spray nozzles require expensive and time consuming clean up, not to mention the cost of the lost chemicals and any time spent applying ineffective mixtures to fields.

A tank mixing order tool supported by a tank mixing order system matches specified agricultural chemical products to their formulation type and recommends a mixing order or sequence based on characteristics of the formulation type. The tank mixing order tool uses a table of mixing order for different formulation types and a formulation type selector, where the formulation type selector matches generic or brand name chemical names to their respective formulation type. Once two or more agricultural chemicals are identified, the tool identifies corresponding formulation types and recommends a mixing order for the identified chemicals. The tool can save previously used mixing orders to reduce the time expended in mixing order development for future applications of the same chemicals. Additionally, the effect of various adjuvants may be included in the determination of the mixing order or specific adjuvants may be recommended based on the combination of chemicals being mixed.

The tool can provide on-line access to label information as well as entry of chemical identification via bar code capture. The tool can also provide additional benefits related to chemical incompatibilities in the way of mixing warnings or precautions. The tool allows compliance to various regulations to be documented via spray logs containing geographic location readings, local weather reports, and specific details of applied chemicals.

### BRIEF DESCRIPTION OF THE DRAWINGS

FIG. 1 is a block diagram of an exemplary system supporting a tank mixing order tool;

FIG. 2 is a block diagram of a mobile device supporting a tank mixing order tool;

FIGS. 3-7 are exemplary screen shots of operation of a web version of a tank mixing order tool;

FIGS. 8-18 are exemplary screen shots of operation of a smart phone version of a tank mixing application;

FIG. 19 is a flow chart of an exemplary method of providing a tank mixing order; and

FIG. 20 is a flow chart of an exemplary method of saving, timing, and logging spray applications sessions.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean. . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

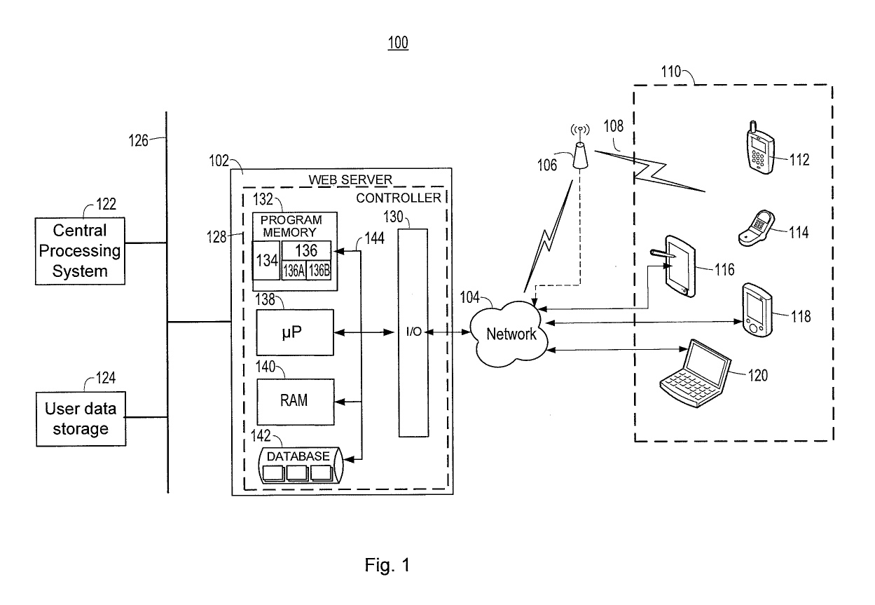

FIG. 1 illustrates various aspects of an exemplary architecture implementing a tank mixing order system 100. The high-level architecture includes both hardware and software applications, as well as various data communications channels for communicating data between the various hardware and software components. A web server 102 may connect over a network 104 to a number of web-enabled devices 110. In some instances, the web enabled devices 110 may communicate with the network 104 via wireless signals 108 and, in some instances, may communicate with the network 104 via an intervening wireless or wired device 106, which may be a wireless router, a wireless repeater, a base transceiver station of a mobile telephony provider, etc. In most cases, the network 104 may be the Internet, however, the network 104 may be a proprietary network, a secure public Internet, a virtual private network or some other type of network, such as dedicated access lines, plain ordinary telephone lines, satellite links, combinations of these, etc. Where the digital network 104 comprises the Internet, data communication may take place over the digital network 104 via an Internet communication protocol.

The web enabled devices 110 may include, by way of example, a smart-phone 112, a web-enabled cell phone 114, a tablet computer 116, a personal digital assistant (PDA) 118, or a laptop/desktop computer 120. Other exemplary user computer or mobile devices may include any web-enabled device appropriately configured to interact with the tank mixing order system 100.

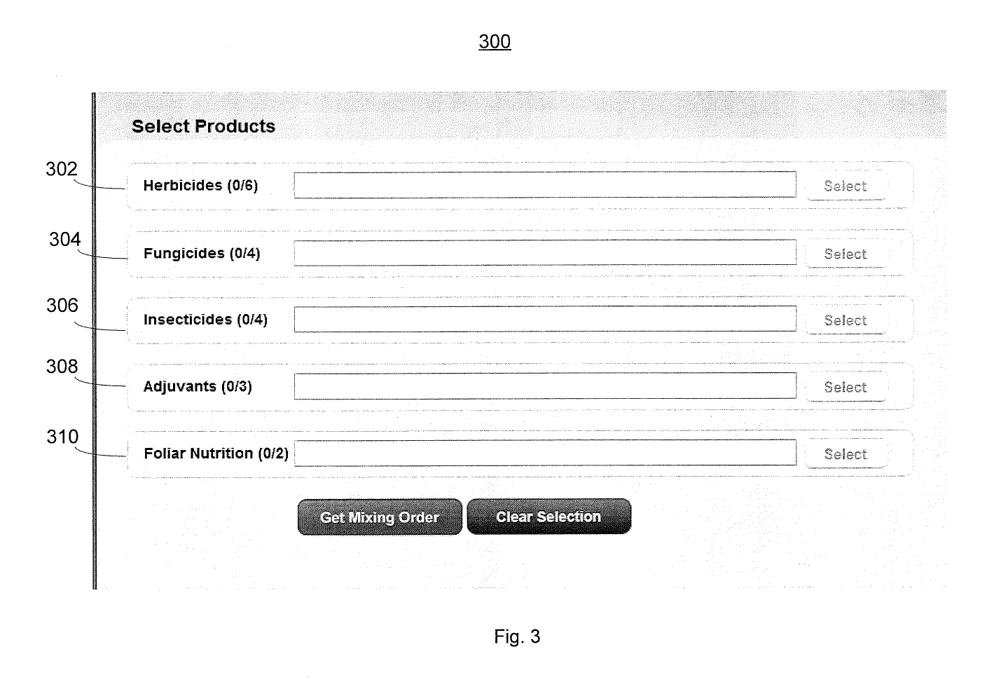

Each of the web-enabled devices 110 may interact with the web server 102 to receive web pages, such as the web page 300 depicted in FIG. 3, for display on a display associated with the web-enabled devices 110. Alternatively, the web server 102 may download an application to the web-enabled device that provides increased local functionality for interacting with the tank mixing system. Examples, of such applications include iPhone® and Android® applications. It will be appreciated that although only one web server 102 is depicted in FIG. 1, multiple web servers 102 may be provided for the purpose of distributing server load, serving different web pages, providing applications, implementing different portions of the tank mixing order system interface, etc.

The web server 102 includes a controller 128. The controller 128 includes a program memory 132, a microcontroller or a microprocessor (μP) 138, a random-access memory (RAM) 140, and an input/output (I/O) circuit 130, all of which are interconnected via an address/data bus 144. The controller may include a clock function (not depicted) capable of providing date and time information as well as providing a timer function, such as a stop watch. The clock function may be a hardware device or may be implemented in a combination of hardware and software. In some embodiments, the controller 128 may also include, or otherwise be communicatively connected to, a database 142 or other data storage mechanism (e.g., one or more hard disk drives, optical storage drives, solid state storage devices, etc.). The database 142 may include data such as customer web profiles, copies of product data, web page templates and/or web pages, iPhone®, Android®, or other applications for downloading and other data necessary to interact with the user devices 110 through the network 104. It should be appreciated that although FIG. 1 depicts only one microprocessor 138, the controller 128 may include multiple microprocessors 138. Similarly, the memory 132 of the controller 128 may include multiple RAMs 134 and multiple program memories 136, 136A and 136B storing one or more corresponding server application modules, according to the controller's particular configuration. Although FIG. 1 depicts the I/O circuit 130 as a single block, the I/O circuit 130 may include a number of different types of I/O circuits (not depicted), including but not limited to, load balancing equipment, firewalls, proxy servers, cache controllers, etc. The controller 128 may implement the RAM(s) 134, 140 and the program memories 136, 136A and 136B as semiconductor memories, magnetically readable memories, and/or optically readable memories, for example, but does not include transitory media such as carrier waves.

The tank mixing order system may further include a central processing system 122 and user data storage 124. The central processing system 122 can be used to create and/or store product formulation type data and mixing order data. The central processing system 122 may be a server the same as or similar to the web server 102 described above. The central processing system 122 may be a conventional server and may include mass storage devices, a database, or both (not depicted). The central processing system 122 may include more than one physical processor or server in known configurations.

The user data storage 124 may be a part of the central processing system 122 or may be a separate server with independent memory. The user data storage 124 may store information from users as discussed in more detail below. Briefly, the user information may include data for an individual user that saves previously entered tank mix product selections or historical data related to a previous application of chemicals by that user.

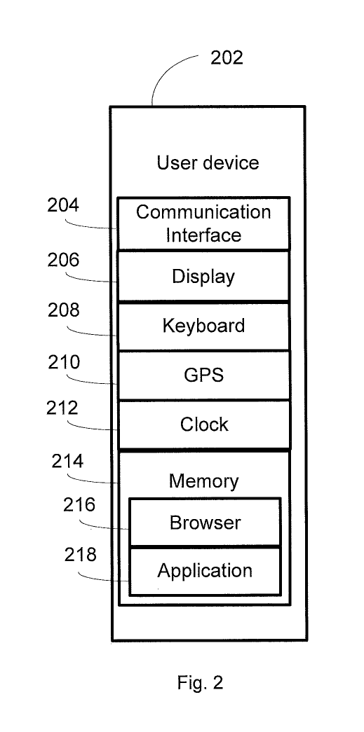

FIG. 2 illustrates a simplified and exemplary block diagram of a web-enabled user device 202, suitable for use in the tank mixing order system 100. The user device 202 may include a wired and/or wireless communication interface 204, a display 206, a keyboard or equivalent touchscreen input device 208, and, in some embodiments, a global positioning system (GPS) 210 and clock function 212. In some embodiments, the clock function 212 may be implemented in a combination of hardware and software. A memory 214 may include volatile and non-volatile storage. In addition to an operating system and other utilities (not depicted), the memory 214 may store a browser 216 and, in some embodiments, a downloaded application 218.

In operation of the tank mixing order tool, two basic modes are supported. The first mode of the tank mixing tool is a web-based client/server embodiment using a browser on the user device 110, and the second mode is an application-based embodiment using a locally installed application with locally installed reference tables.

First, looking at the web-based client/server embodiment, a user at a user device 110, with a browser 214 may enter a universal record locator (URL) and may be presented with an initial screen, such as screen 300 of FIG. 3. A series of selection boxes 302-310 may be shown on the initial screen, where each of the selection boxes 302-310 represents large categories of products. These large categories of products may include herbicides, PGRs (plant growth regulators), defoliants, fungicides, bactericides, insecticides, IGRs (insect growth regulators) and miticides, as well as adjuvants that can promote the effects of chemical products from other categories. In some embodiments, some categories are combined to preserve screen space. For example, the miticides product category may be included with insecticides product category 306. In further embodiments, adjuvants are recommended to the user to increase product efficacy.

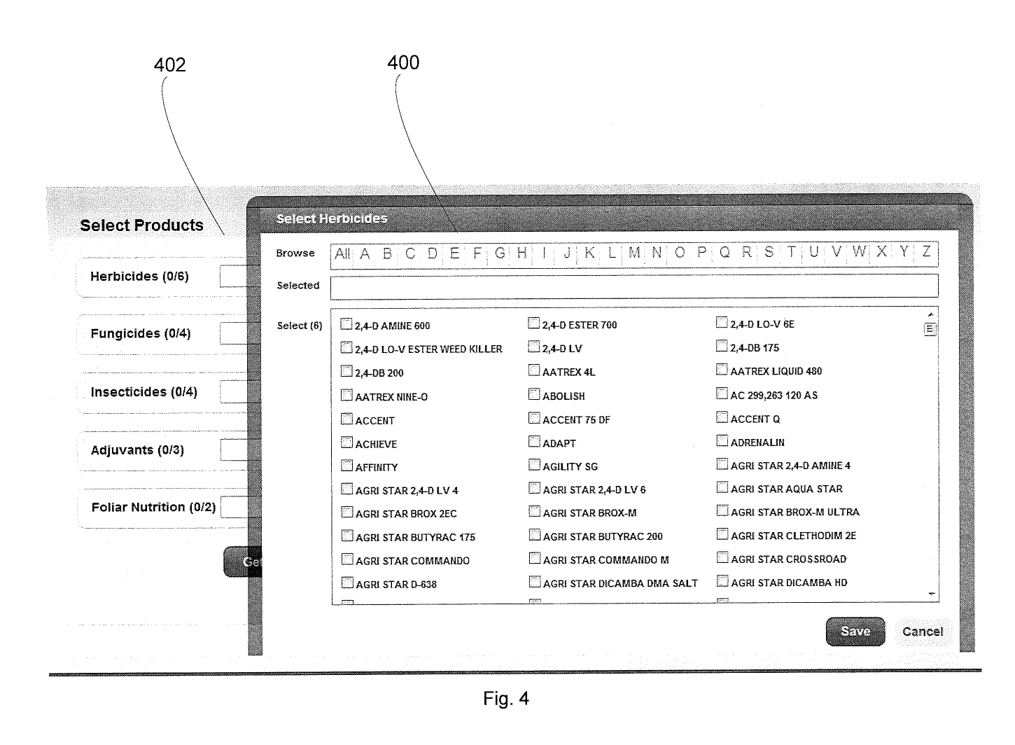

Selection of a product category (e.g. the fungicides product category 304) may cause presentation of a product selection window, or similar selection function. FIG. 4 illustrates an exemplary product selection window 400. The tool presents similar upon selection of the other product categories 301-310. In an embodiment, a product selection window 400 may be returned to at any time during product selection to allow previously selected products to be removed from the mix, or to add an additional product from that category.

In some embodiments, product selection windows, such as product selection window 400, include indications of favorite (i.e. preferred) products. For example, a star or other highlight may be displayed next to a product that is frequently selected by a user of the user device 110. Alternatively, a user may manually select some of the products as favorites such that they are highlighted in future instances of the presentation of the product selection window 400.

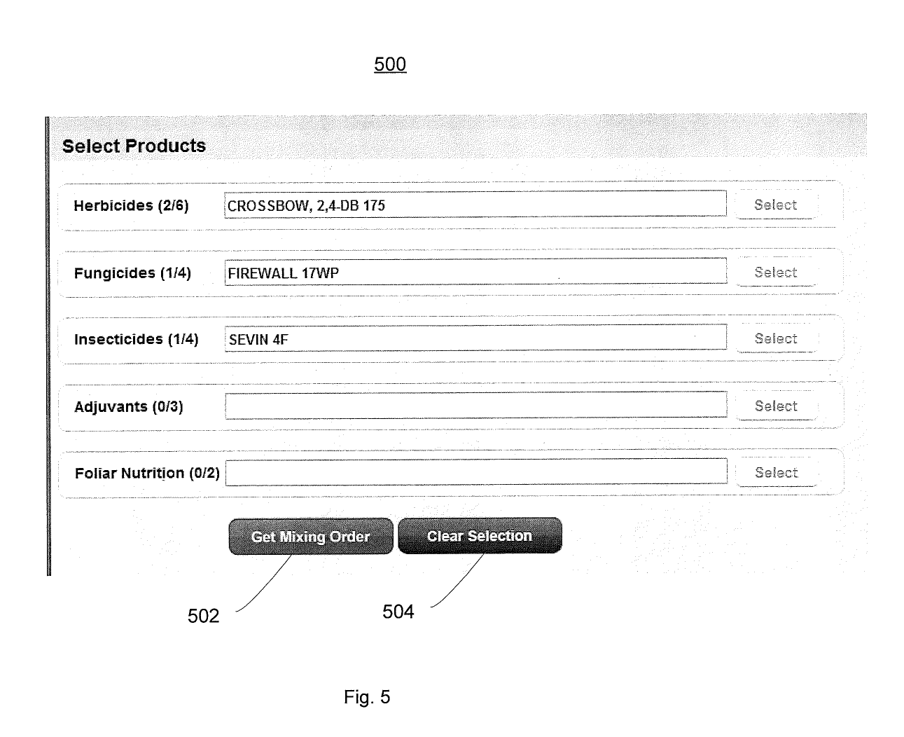

FIG. 5 illustrates an initial screen in which product categories have been populated via a product selection window, such as the product selection window 500. In this example, a user has selected one each of a brand name herbicide, fungicide and insecticide, and one generic herbicide (2,4-DB 175). Button 502 allows a user to request a mixing order for the selected chemicals, and button 504 allows session user to clear the selected products and return to a clear initial screen, such as the initial screen 300 shown in FIG. 3.

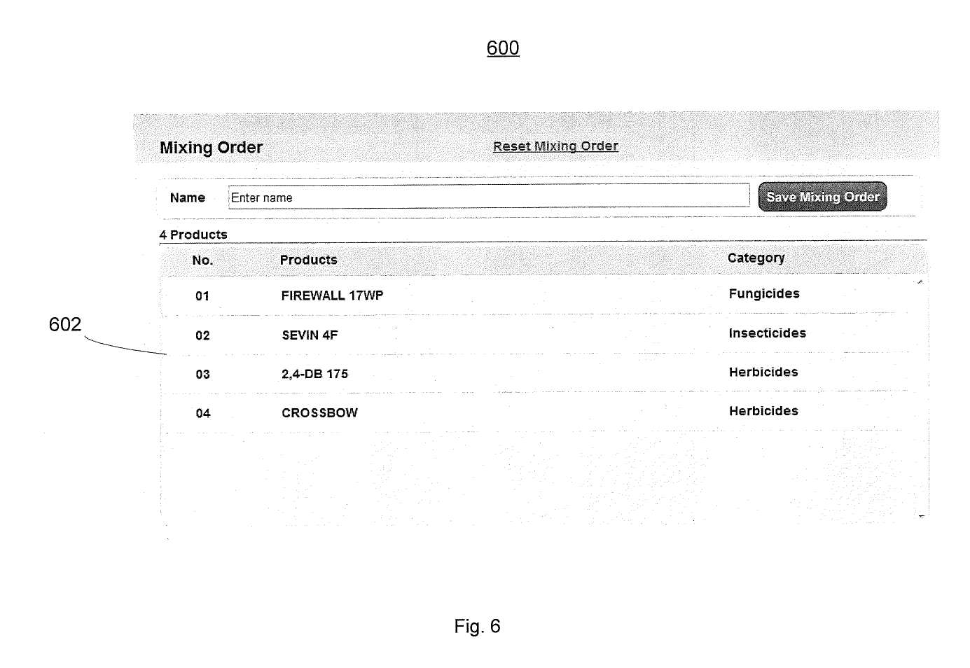

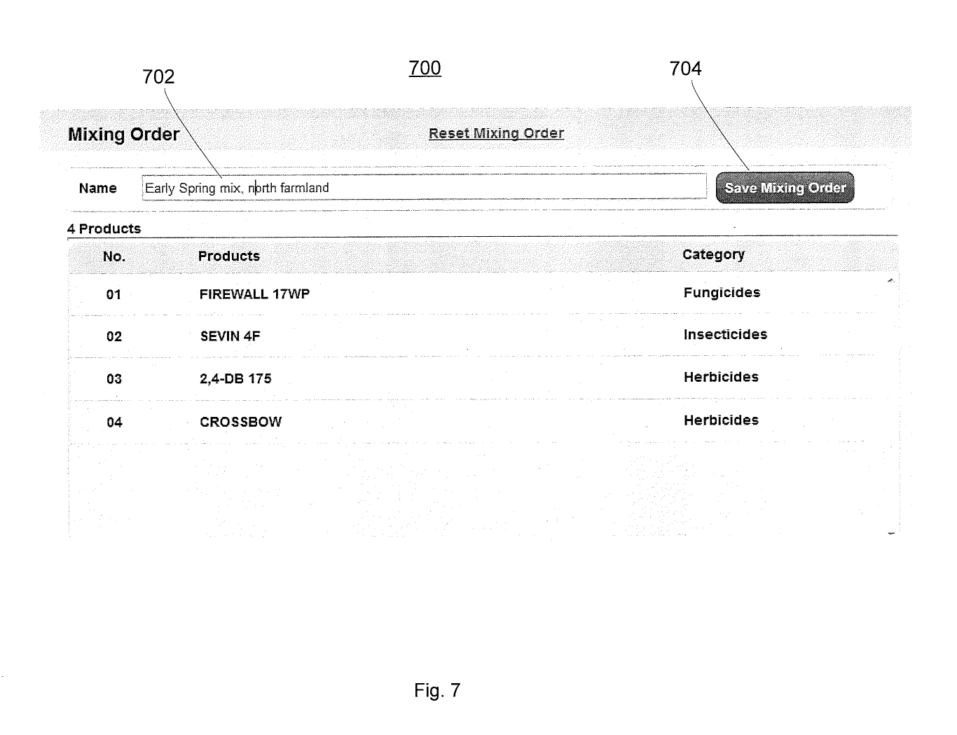

FIG. 6 illustrates an exemplary mixing order window 600 for the selected products indicated in FIG. 5. The products are assigned an ordinal number (e.g. 01, 02, 03, etc) and listed in sequence 602. In addition to the order, as indicated by the ordinal numbers, the mixing order window may include the names of the chemicals and the corresponding chemical categories. The mixing order in the mixing order window 600 may be saved. FIG. 7 illustrates a mixing order window 700 with a name entry box 702, where the user may enter a descriptive name for the mixing order, and an associated save button 704. A representation of the mixing order, presented below the name entry box 702, may be saved via selection of the save button 704. In some embodiments, the saving feature is available only when the user is logged into the system using a unique identifier and optional password.

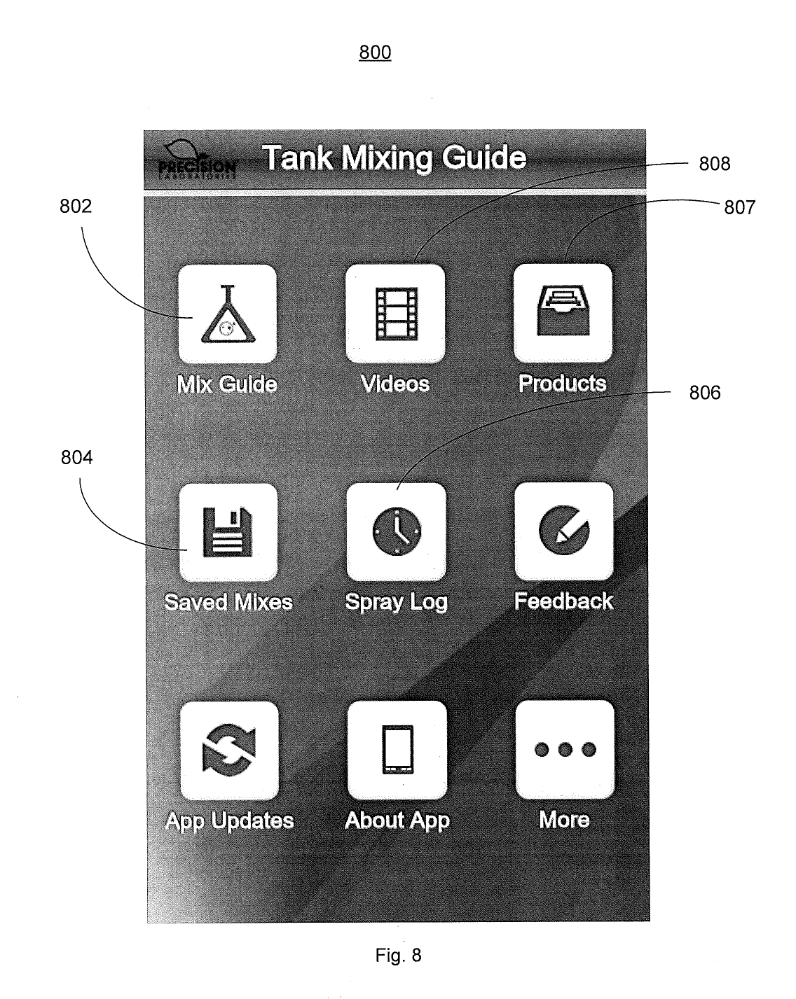

Turning to the application-based embodiment, FIGS. 8-17 illustrate a tank mix application 218, implemented on a smartphone, tablet, or similar device. Upon navigating to the tank mixing tool, via a browser, for example, the user is offered an opportunity to download an application 218. Alternatively, the user may select and download the application from an application store, known in the industry.

After executing the application 218, the tank mixing order tool presents initial page 800, where execution of the application may be initiated by a user navigating to and opening the tank mixing order tool on the user device 110. Icons on the initial page 800 allow selection of a number of internal applications or instructional aides. For example, a mix guide icon 802 accesses the tank mix order application, a saved mixes icon 804 accesses previously saved tank mixes, a spray log icon 806 accesses the spray log application, discussed in more detail below, a products icon 807 accesses chemical product information, such as product labels and Material Safety Data Sheets (MSDS), and a videos icon 808 accesses instructional videos.

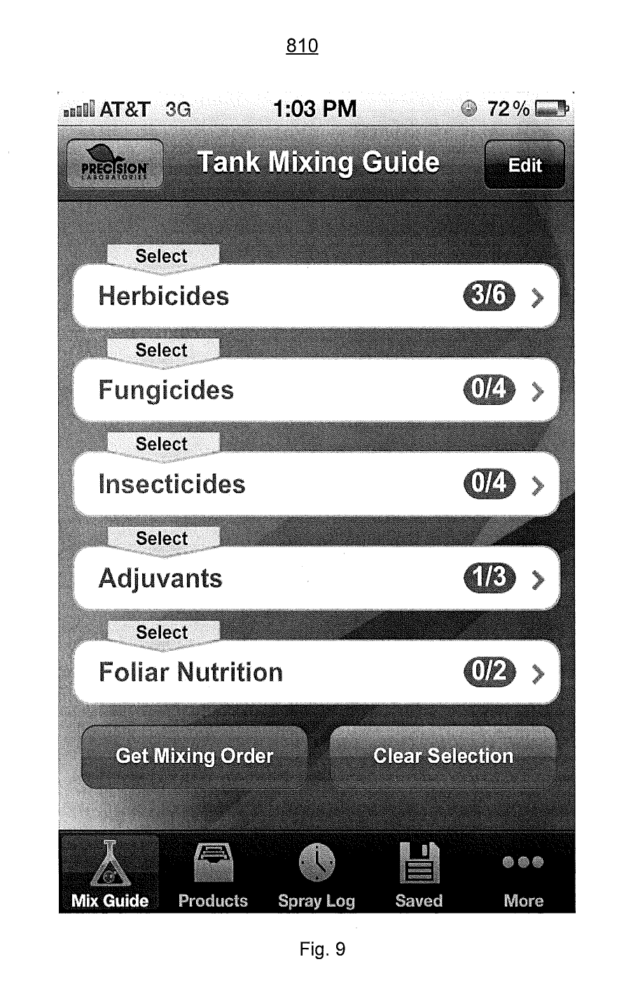

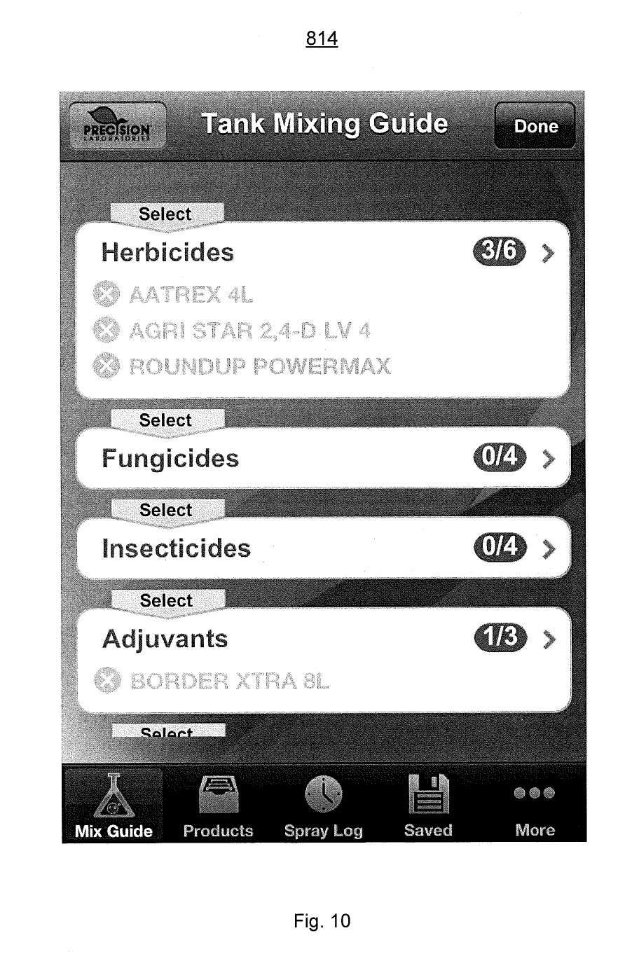

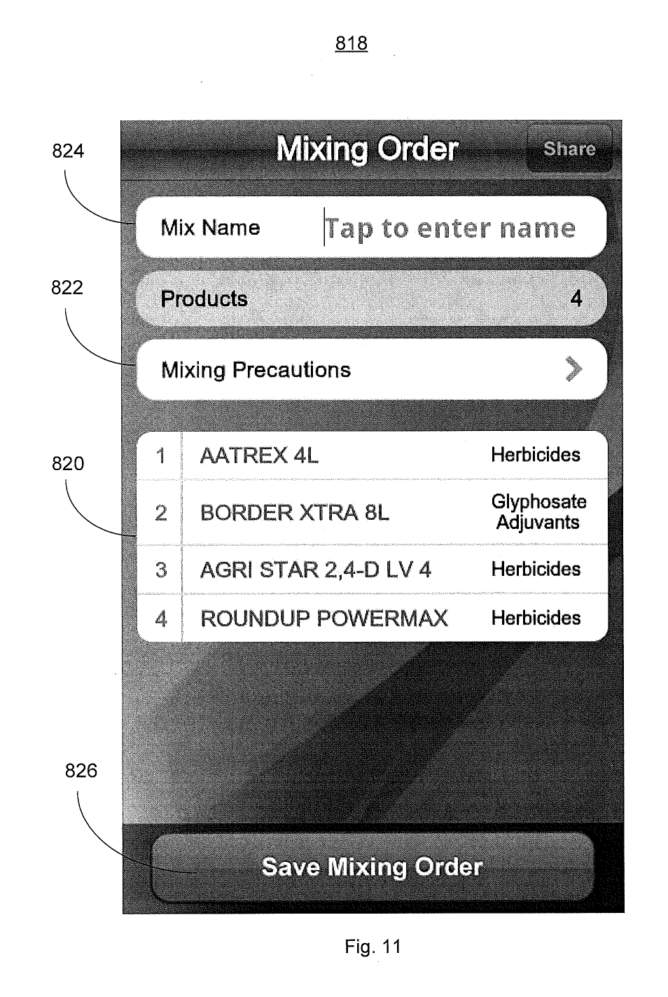

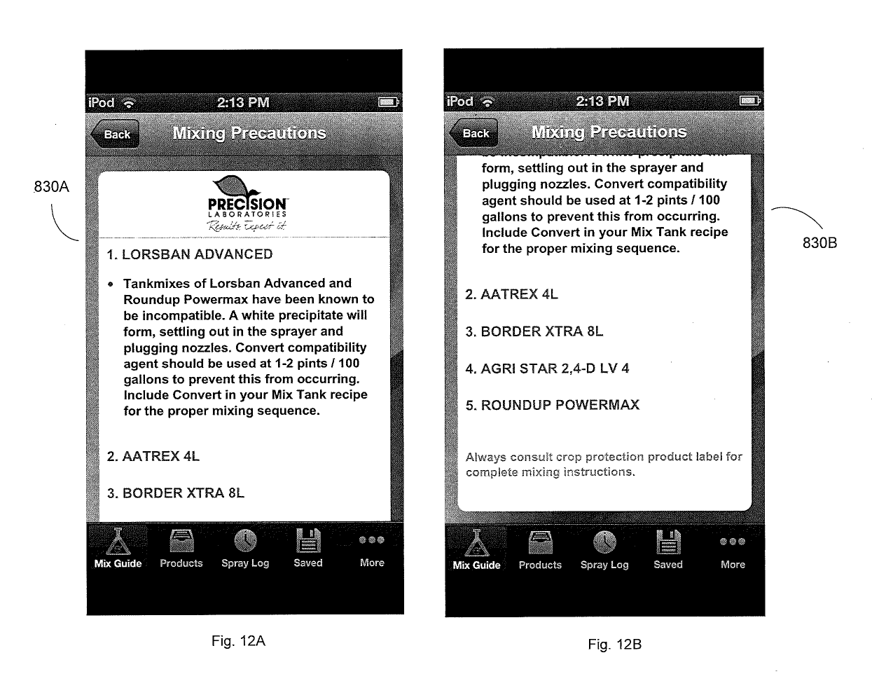

Selection of the mix guide icon 802, for example, starts the internal mix guide application. FIG. 9 illustrates an embodiment of an initial screen 810 for the mix guide application. The internal mix guide application of the application 218 allows the user to select from a number of chemical application products. As shown, three example herbicides and one example adjuvant have been selected. Activating the select button for a particular chemical type permits the user to either select additional chemicals or deselect a previously selected chemical. For example, FIG. 10 illustrates one embodiment 814 of an active select button showing previously selected chemicals from two groups. In this embodiment, a limit is placed on the total number of chemicals from each category that may be selected, for example. FIG. 10 shows that three example herbicides of a maximum number of six herbicides have been selected. FIG. 11 shows an exemplary screen shot 818 illustrating a generated mixing order 820 for the chemicals selected in the example illustrated in FIG. 10.

In some embodiments, the tool displays Environmental Protection Agency (EPA) registration numbers with the selected or selectable chemical application products. The EPA registration number may be displayed in a product selection window, such as the product selection window 400, and/or in a mix guide application, such as in the initial screen 810.

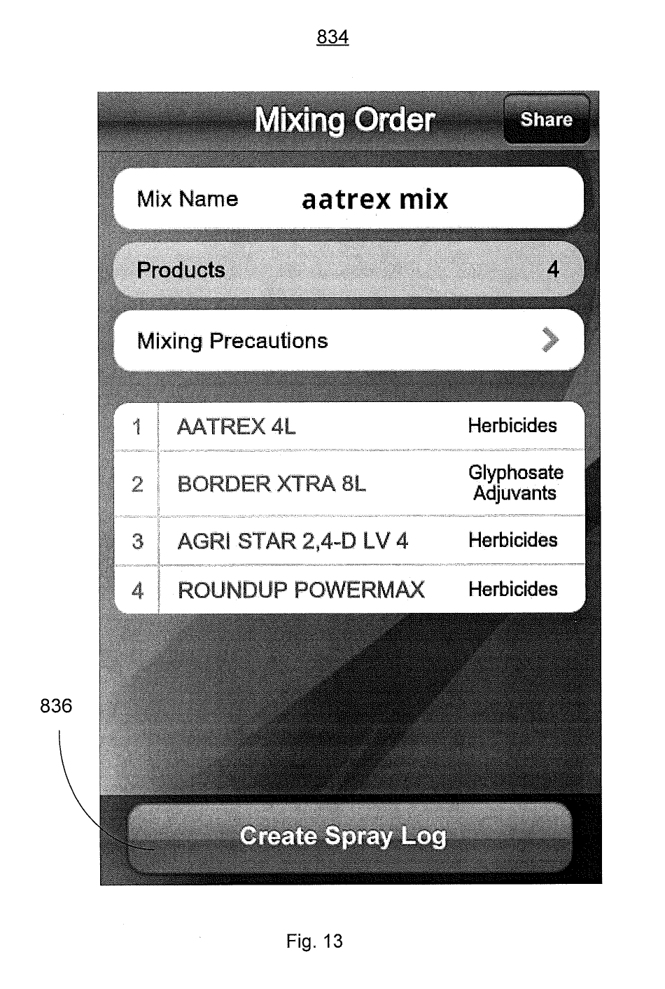

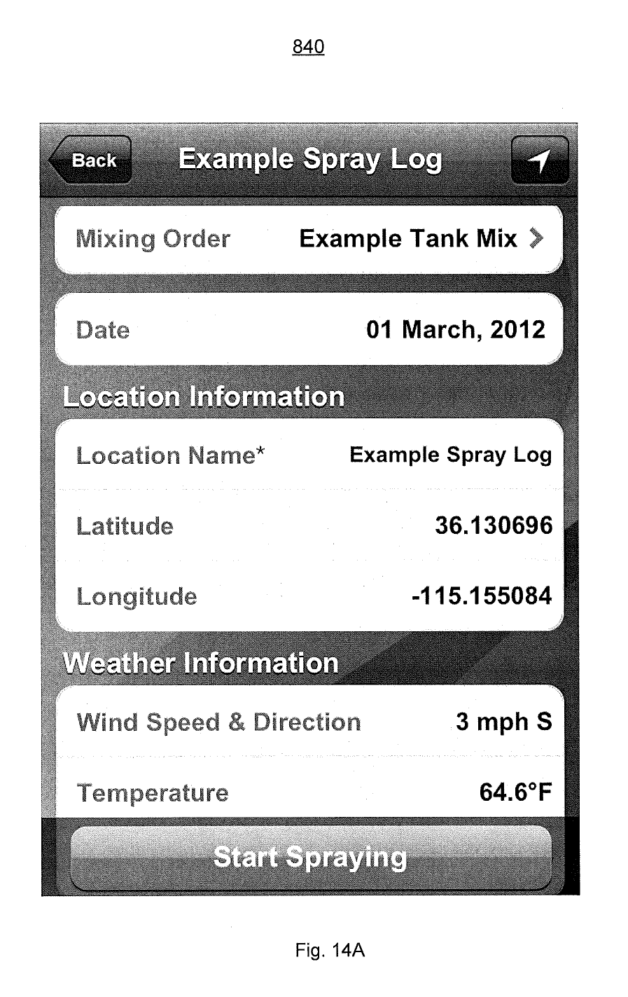

Activating the Mixing Precautions button 822 may cause the display of a scrollable window 830A and 830B of FIG. 12A and FIG. 12B showing exemplary mixing instructions. In some embodiments, the mixing precautions button 822 is presented to the user only when the mixing order 820 has corresponding mixing precautions. Additionally, the mixing precautions button 822 may provide an indication of the number of mixing precautions corresponding to the mixing order 820. Similar to the web-based server/client embodiment discussed above, the name entry box 824 and Save Mixing Order button 826 may cause the selected chemicals and corresponding mixing order to be saved for future reference. FIG. 13 illustrates an exemplary screen shot 834 of a saved mixing order.

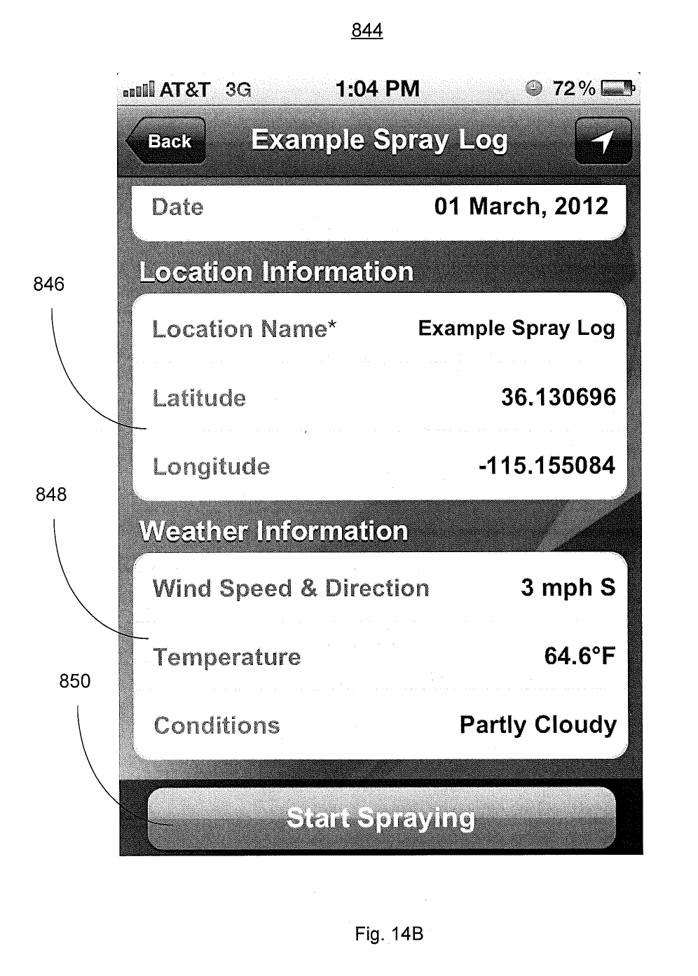

Selection of a Create Spray Log button 836 activates a spray log feature that allows logging of spray applications. The laws of some jurisdictions require such logs. FIG. 14A shows a first portion 840 of an example spray log screen. FIG. 14B shows a second portion 844 of the example spray log screen of FIG. 14A. A Location Information section 846 may display location information collected via a Global Positioning System (GPS) receiver in the smart phone, if available. When a data connection is available, the location information may be used to query a weather reporting system to automatically populate a Weather Information area 848 with official weather information for that location. In another embodiment, the location data, the weather data, or both, may be manually entered.

In some implementations, the initial application screen, such as the initial screen 800, includes a dedicated weather data icon. Selection of the weather data icon may trigger the presentation of current weather data corresponding to the current location of the user device or historical weather data corresponding to previously saved spray logs.

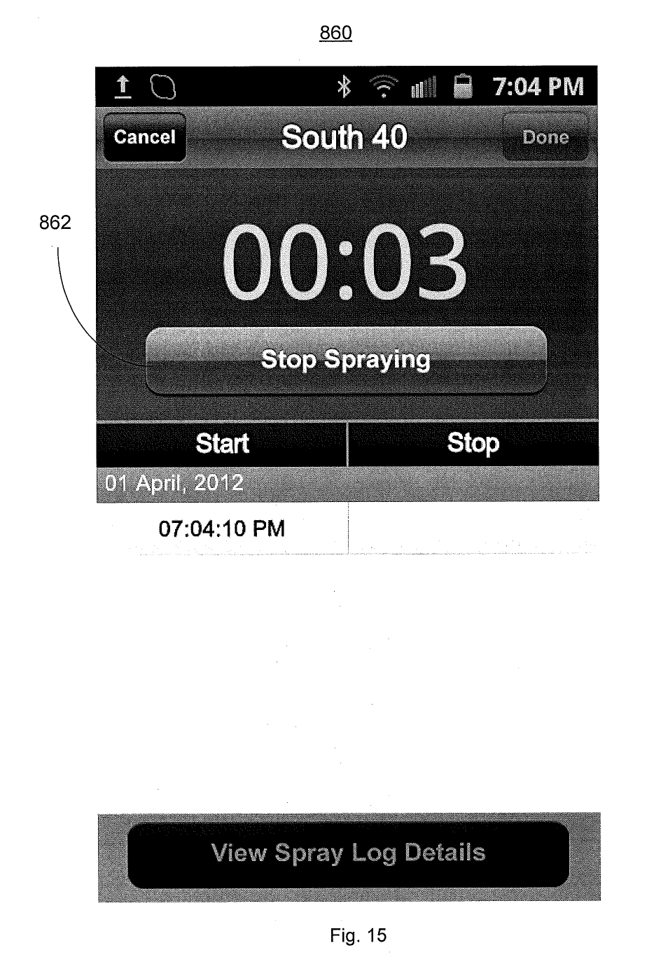

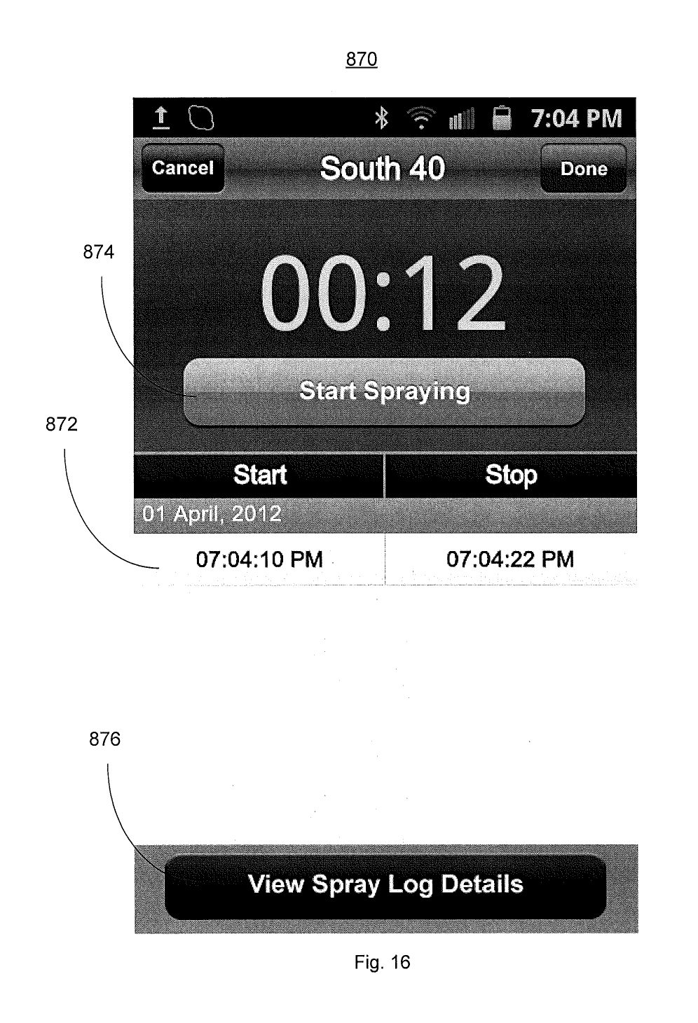

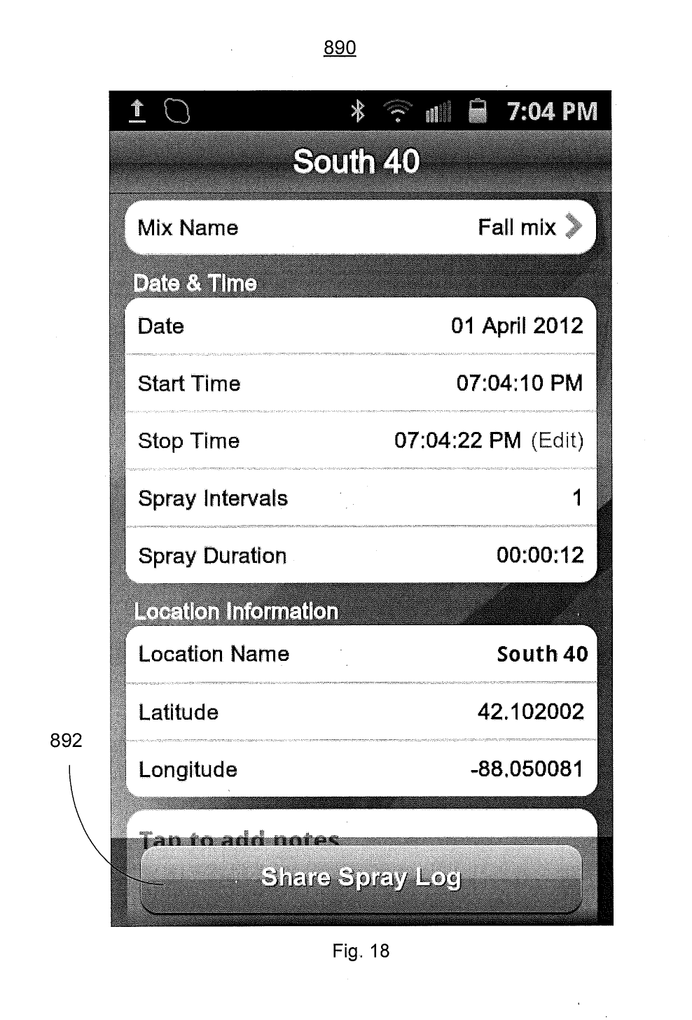

The spray log feature provides the ability to capture a duration of an application process by activating the Start Spraying button 850. FIG. 15 illustrates an exemplary screen shot 860 of a spray application timer. Selecting the Stop Spraying button 862 will end the spray session, and, in some implementations, the spray application timer provides the user with periodic alerts if one or more spray sessions are active. FIG. 16 illustrates a screen shot 870 of a completed spray interval. A summary area 872 shows the start and stop times. A Start Spraying button 874 allows capture of a second spray interval (not depicted), for example, after refilling a spray tank. A View Spray Log Details button 876 allows display of a spray log of the spraying activity by activating a screen depicted in FIG. 18, where the display of a spray log may include mixing order, date, location information, weather information, and EPA registration numbers. The display of a spray log may also include a notes field where the user enters text notes to be stored with the spray log.

In some embodiments, the display of a spray log includes a calculator field where the user adds select use rates (e.g. volume/acre) for each of the selected chemicals in the tank mix order. Further, the calculator field may allow the user to record units of measure, size of spray tanks, and the size of the sprayed areas. This additional calculator information may be saved with other spray log information, such as mixing order, date, location information, etc., as a comprehensive spray log.

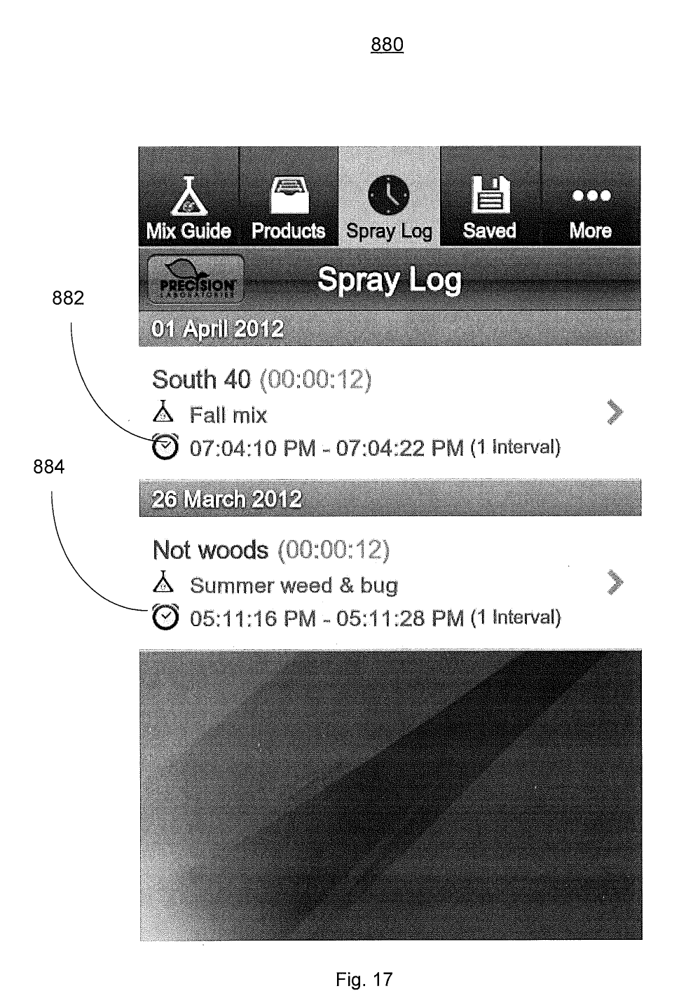

FIG. 17 illustrates a spray log summary for two spray sessions 882, 884, each having one interval. The selection of one of the respective intervals will trigger the display of a spray log detail page. FIG. 18 illustrates a detail page 890 for a saved spray session, such as spray session 882 of FIG. 17. Further, selection of a Share Spray Log button 892 may facilitate sending the spray log via email or Bluetooth to another computer. Thus the spray log feature may simplify the capture of data required for reporting chemical applications in some jurisdictions.

In some embodiments, the application may be completely downloaded to the smart phone 202 so that the application operates without network access, although some features, such as automatic weather information, may not be available in that case. That is, all mixing sequence and product to formulation data as well as mixing order algorithms are saved on the smart phone 202 or other similar user device. It is desirable to have the locally-saved application periodically check for updates to the application 218 that may affect the product listings or formulation types (discussed more below). Although in one embodiment the local application 218 stores all the necessary data for implementing mixing order selection, other embodiments may include various amounts of interactivity, either to save space on a user device 110, or simply to use the most current chemical or algorithm data when a network connection is available.

In some embodiments, the mix tank order tool may employ an image capture module of the user device 110 to capture imagery of sprayed areas. For example, the image capture module may be a charge couple device (CCD) camera on a common smartphone. The captured imagery of the field may be saved in the memory of the user device 110 and/or shared, via email, for example, along with GPS location information and a timestamp (e.g. latitude, longitude, time, and date). In some implementations, the tool displays multiple images of the sprayed area along with a map of the sprayed area that indicates locations of respective image capture. The user may track and comment on field progress by reviewing the images over time and by making notes in a note field.

Specifying a mixing order can be broken into several parts. One part is the development of a mixing sequence, or mixing order, by formulation type. Table 1, below, shows a representative list of chemical formulation types in a sequence according to the order in which they should be added to a water or liquid fertilizer solution. The current embodiment uses the assumption that all the chemicals will be delivered in a water-based mix, therefore, water is the first ingredient.

TABLE 1

| MIXING | | | | | |
|---|---|---|---|---|---|
| ORDER | ABBR. | EQUIVALENTS | | | FORMULATION TYPE |
| 1 | W | | | | Water |
| 2 | C | | | | Compatibility Agent |
| 3 | EW | | | | Aqueous Emulsion |
| 4 | WSP | WS | | | Water Soluble Packet |
| 5 | WP | SP | P | W | Wettable Powder |
| 6 | DF | | | | Dry Flowable |
| 7 | WDG | DG | | | Water disperable |
| | | | | | granular |
| 8 | SG | WSG | | | Water Soluble Granule |
| 9 | WG | | | | Wettable Granule |
| 10 | AMS | | | | Ammonium Sulfate |
| 11 | DDR | | | | Dry drift retardant |
| 12 | SE | | | | Suspoemulsion |
| 13 | AS | | | | Aqueous Suspension |
| 14 | FC | F | | | Flowable Concentrate |
| 15 | FL | WDL | | | Flowable |
| 16 | SC | SF | | | Suspension |
| | | | | | Concentrate |
| 17 | LDR | | | | Liquid drift retardant |
| 18 | ME | | | | Micro encapsulated |
| 19 | ES | | | | Emulsion suspension |
| 20 | LC | | | | Liquid concentrate |
| 21 | EC | E | | | Emulsifiable |
| | | | | | concentrate |
| 22 | SL | | | | Soluble Liquid |
| 23 | L | S | SL | WSL | Liquid |
| 24 | CS | | | | Capsule Suspension |
| 25 | COC | | | | Crop oil concentrate |
| 26 | MSO | | | | Modified seed oil |
| 27 | HSOC | | | | High surfactant oil |
| | | | | | concentrate |
| 28 | NIS | | | | Nonionic surfactant |
| 29 | WC | | | | Water conditioner |

As shown in Table 1, a water dispersible granular formulation type (no. 7) should be mixed before adding a suspension concentrate (no. 16). Equivalent formulation types are shown in the same row and when more than one equivalent chemical is selected, the corresponding products are assigned a mixing order, for example, either alphabetical or in the sequence selected.

Another part of specifying the mixing order is the identification of chemicals by their formulation type. In an embodiment, each chemical available for selection is identified either by brand name or generic equivalent and is associated with its formulation type. In some cases, the formulation type may be listed on the label, but in other cases the manufacturer must identify the formulation type. After identification of each chemical by formulation type, an index may be developed of product by formulation type.

The tank mixing order application, whether web-based or application-based (e.g. supported by application 218) then presents the list of products, receives a selection from those products, and does an index look up, or equivalent, of product to formulation type. The formulation types are identified in a second index look up to identify the mix order number from, for example, Table 1. Lastly, the products are ordered according to the corresponding mix order number and presented to the user.

As discussed above with respect to FIG. 7, the selected products and mix order may be saved for future use. For local application-based embodiments, the saved results may be stored locally on the user device 110 and uploaded to the user data storage device 124 when network connectivity is available. Further, other customer records may be stored on the system, either locally or at the user data storage device 124. These records may include a user name, address, contact information, as well as chemical application histories, discussed below.

In some locations, a record of chemical applications must be kept. These records often include the chemicals applied, the location of the application, the date, and the weather (e.g. wind speed that may affect spray drift). The tank mixing order application or tool 218 may collect the date, time and location from the GPS receiver 210 and compile that information with the chemicals from the tank mixing selection. Integration with a local or server-side weather application (not depicted) allows retrieval of weather conditions for that geographic area on that day (and time if necessary). Therefore, compliance to chemical application reporting is greatly simplified using the single user-device based mixing order tool 218.

An additional feature of the tank mixing order tool 218 is the ability to capture one-dimensional or two-dimensional bar code information and either using a local look-up or server-based information, returning the chemical product name for use when selecting chemicals in the mixing order tool 218.

Another feature of the tank mixing order tool 218 or web-based application is the ability to retrieve, either locally or via a network connection, label data for each selected chemical. Agricultural product labels may be several pages or more in length, with detailed information about storage, application rates, mixing proportions, health cautions, etc. However, the storage environment for these containers is not always conducive to preservation of the labels. Dirt, abrasion, spills, and other events may cause the labels to be lost or unusable. The ability to retrieve label data via the tool 218 provides an additional benefit to the end user.

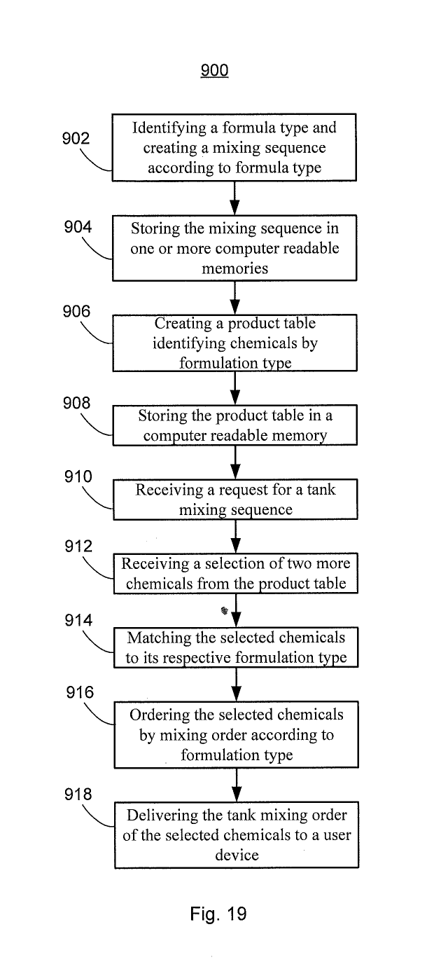

FIG. 19 is a flow chart of an exemplary method 900 of providing a tank mixing order, that is particularly applicable to, but not limited to, water soluble chemicals.

The method involves identifying a formulation type for chemicals and creating a mixing sequence according to the formulation type (block 902). The mixing sequence according to formulation type may be stored on a computer readable media (block 904), either at a server 122, database 142, or at a memory 212 of a user device 110, such as a smartphone 112.

A product table may be created identifying a plurality of brand name or generic agricultural chemicals by respective formulation type (block 906) and stored in computer readable memory (block 908), either at a server 122, database 142, or at a memory 212 of a user device 110, such as a smartphone 112.

A request for a mixing sequence may be received over a network from a user device or at a user device application (block 910). The server 122 or 102 or a user device may receive a selection of two or more chemicals appearing in the product table (block 912). The two or more chemicals may be matched to their respective formulation types using the product table (block 914). The two or more chemicals may be ordered by their respective formulation types using the mixing sequence (block 916). The chemicals sequenced in the mixing order may be delivered to a user device 110 (block 918) for display via a user interface. Alternatively, if the tank mixing order application is stored and executed locally, the results may simply be displayed via the user interface.

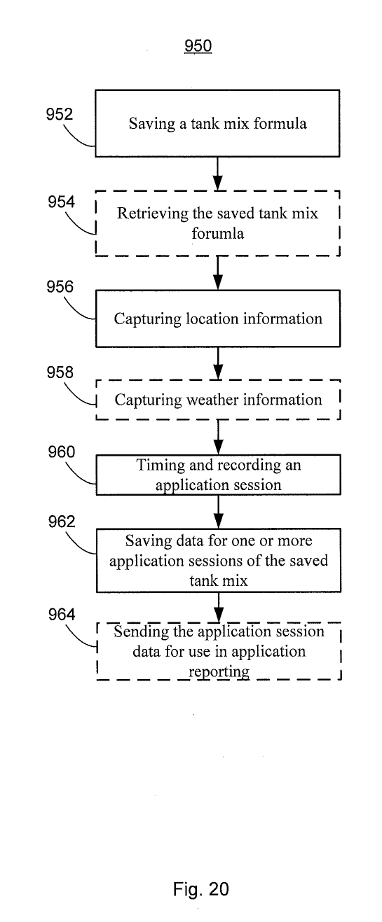

FIG. 20 is a flow chart of an exemplary method 950 of saving, timing and logging spray application sessions. After entering chemicals and receiving a tank mix order, as described above with respect to FIG. 19, the selected chemicals and tank mix may be saved for later use (block 952). The tank mix may be given a descriptive name for ease of identification. The tank mix may be saved locally, for example, on a smart phone 112 or may be saved at a web site or in the cloud.

If the tank mix information is to be used for spray application logging, a previously stored tank mix formulation may optionally be retrieved for use in creating the spray log (954). If the current mix is to be applied, the information available from entering the data for the tank mixing order may simply be used. Location information may be captured either manually or via a built-in GPS unit (block 956).

Optionally, weather information may be manually or automatically added to the spray log (block 958). If no weather information is added at the time of spraying, the weather information may be added later using almanac data for the date, time and location.

When the spray session is started, a timer may be activated on the smart phone 112 or similar device being used. When the spray session is concluded, the timer may be deactivated (block 960). At that point, the start/stop and durations of the spray application may be logged. As discussed above, if other intervals of spray application are performed, those additional intervals may also be recorded (block 962).

At a convenient time, such as when spraying is concluded and network connectivity is available, the spray log may optionally be sent to another device for use in spray application reporting.

This detailed description is to be construed as exemplary only and does not describe every possible embodiment, as describing every possible embodiment would be impractical, if not impossible. One could implement numerous alternate embodiments, using either current technology or technology developed after the filing date of this application.

We claim:

1. A method of providing, at a computing device, a tank mixing order for chemicals comprising:
storing a mixing sequence in one or more computer readable memories, the mixing sequence identifying a mixing sequence by formulation type for a plurality of chemicals that are applied via water or liquid fertilizer solutions;
storing a product table identifying a plurality of brand name or generic chemicals by respective formulation type in the one or more computer readable memories;
receiving, via a user interface of the computing device, a request for a mixing sequence of chemicals;
displaying at least a portion of the product table at a user interface of the computing device;
receiving, via the user interface of the computing device, a selection of two or more chemicals from the product table;
matching the two or more chemicals to its respective formulation type;
ordering the two or more chemicals into a tank mixing order determined by its respective formulation type in the mixing sequence; and
displaying the tank mixing order of the one or more chemicals to the user interface of the computing device.

2. The method of claim 1, further comprising:
receiving a copy of the mixing sequence according to formula type at the computing device.

3. The method of claim 2, further comprising:
receiving a copy of the product table identifying a plurality of brand name chemicals by respective formula type at the computing device.

4. The method of claim 1, further comprising:
receiving a geographic location of the computing device from a global positioning satellite (GPS) device in the computing device.

5. The method of claim 4, further comprising:
identifying current weather at the geographic location of the computing device;
receiving chemical application data from the computing device; and
storing a user identifier, the geographic location, the current weather, and the chemical application data for use in chemical application compliance reporting.

6. The method of claim 1, wherein receiving a selection of two or more chemicals comprises receiving an image of bar code data from a container of at least one of chemicals.

7. The method of claim 6, wherein the receiving image of bar code data comprises receiving one of an image of a one-dimensional bar code data and a two-dimensional bar code data.

8. The method of claim 1, wherein each chemical is a water soluble or oil soluble chemical used in the application of pesticides.

9. The method of claim 1, wherein the one or more computer-readable memories are on a server device connected via a network to the computing device.

10. The method of claim 1, further comprising:
identifying a formulation type for chemicals delivered via a water or liquid fertilizer solution;
creating the mixing sequence according to formulation type; and
creating the product table identifying a plurality of brand name or generic chemicals by respective formulation type.

11. A computer for providing recording a spray application session for a plurality of chemicals applied via a water or liquid fertilizer soluble spray, the system comprising:
a processor;
a user interface comprising a display and an input device coupled to the processor;
a port coupled to the processor for communication of data via a network; and
a memory coupled to the processor storing executable code that when executed on the processor cause the computer to:
store a mixing sequence in one or more computer readable memories, the mixing sequence identifying a mixing sequence by formulation type for a plurality of chemicals that are applied via a water or liquid fertilizer soluble spray;
store a product table identifying a plurality of brand name or generic chemicals by respective formulation type in the one or more computer readable memories;
receive, via a user interface of the computing device, a request for a mixing sequence of chemicals;
display at least a portion of the product table at a user interface of the computing device;
receive, via the user interface of the computing device, a selection of two or more chemicals from the product table;
match the two or more chemicals to its respective formulation type;
order the two or more chemicals into a tank mixing order determined by its respective formulation type in the mixing sequence;
display the tank mixing order of the one or more chemicals to the user interface of the computing device;
identify a geographic location of the computing device;
identify a current weather at the geographic location of the computing device;
capture chemical application data;
store a spray log comprising a user identifier, the geographic location, the current weather, and the chemical application data for use in chemical application compliance logging.

12. The computer of claim 11, wherein the memory stores further executable code that when executed on the processor cause the computer to:
receive the mixing sequence and product table via the port over the network.

13. The computer of claim 11, wherein the memory stores further executable code that when executed on the processor cause the computer to:
send the spray log to another computer via the port over the network.

14. The computer of claim 11, further comprising a global positioning satellite (GPS) receiver, wherein the memory stores further executable code that when executed on the processor cause the computer to:
automatically identify the geographic location of the computing device.

15. The computer of claim 11, further comprising a clock function used to capture chemical application data comprising a date, a time, and a duration of a spray application.

16. The computer of claim 11, wherein the spray log includes geographic location expressed in latitude and longitude and the current weather is expressed in wind speed and direction, temperature, and cloud cover.

17. A method of serving a tank mix application and spray reporting function at a computer server via a network to a client device, the method comprising:
identifying a formulation type for chemicals;
creating a product table identifying a plurality of brand name or generic chemicals by respective formulation type;
storing the product table identifying a plurality of brand name or generic chemicals by respective formulation type in one or more computer readable memories accessible by the computer server;
creating a mixing sequence according to formulation type;
storing the mixing sequence in the bone or more computer readable memories accessible by the computer server;
receiving, via the network from the client device, a request for a mixing sequence of chemicals;
sending the product table to the client device;
receiving, via the network from the client device, a selection of two or more chemicals from the product table;
matching the two or more chemicals to its respective formulation type;
ordering the two or more chemicals into a tank mixing order determined by its respective formulation type in the mixing sequence;
sending the tank mixing order of the one or more chemicals to the client device via the network;
receiving a geographic location, weather at the time of chemical application, and chemical application data from the client device; and
storing a user identifier, the geographic location, the weather, and the chemical application data for use in chemical application compliance reporting.

18. The method of claim 17, wherein the chemicals are agricultural chemicals applied via a spray in a water-based solution.

19. The method of claim 17, wherein receiving the selection of two or more chemicals comprises receiving a bar code image corresponding to one of the chemicals.

20. The method of claim 17, further comprising receiving the geographic location as longitude and latitude coordinates taken from a GPS receiver at the client device.
